(19) United States
(12) Patent Application Publication
(10) Pub. No.: US 2018/0058611 A1
(43) Pub. Date: Mar. 1, 2018

(54) CLAMPING ASSEMBLY

(71) Applicant: Caterpillar SARL, Geneva (CH)

(72) Inventors: Hugh Rillie, JR., Cary, NC (US); Kayla J. Sturgis, Sanford, NC (US); Kevin H. Gordon, Apex, NC (US); Leigh H. Davenport, Sanford, NC (US)

(73) Assignee: Caterpillar SARL, Geneva (CH)

(21) Appl. No.: 15/246,588

(22) Filed: Aug. 25, 2016

(51) Int. Cl. F16L 3/237; F16L 3/10; F16L 3/223

(52) U.S. Cl. CPC F16L 3/237; F16L 3/2235; F16L 3/10

(57) ABSTRACT

A clamping member for attaching a hose with a frame of a machine is disclosed. The clamping member includes a first receptacle, a second receptacle, and a mounting portion defined between the first receptacle and the second receptacle. The clamping member includes a locating member disposed at a first distance from a first end of the mounting portion and a holding portion defined at a second distance from a second end of the mounting portion. The first distance and the second distance are equal. The clamping member further includes a plurality of engaging members defined at the first end of the mounting portion and a leg member having a tab disposed at the second end of the mounting portion. The tab conforms with the plurality of engaging members.

### TECHNICAL FIELD

The present disclosure relates to a clamping assembly, and more particularly relates to the clamping assembly for attaching a hose with a frame of a machine.

### BACKGROUND

Machines, such as skid steer loaders are commonly used in earth moving operations. Such machine is equipped with an implement system as per the application of the machine at a worksite. The machine is further equipped with a hydraulic system to supply hydraulic fluid, at a desired pressure, to the implement system and in turn to actuate the implement system. The hydraulic system includes fluid reservoir, pumps, and various control elements such as valves, and actuating elements such as hydraulic cylinders. The fluid reservoir and the pumps of the hydraulic system are usually disposed in an enclosure provided within the machine and further fluidly coupled to the implement system and the various control elements via hoses. The hoses are routed to the implement system and the various control elements along a length and a breadth of a frame of the machine. In order to prevent the hoses from entangling with moving parts of the machine, such as the implement system, the hoses are clamped to the frame of the machine using a clamping arrangement. However, due to significant variation in the pressure of the hydraulic fluid flowing through the hoses, the hoses may tend to release themselves from the clamping arrangement. Accordingly, it is necessary to securely clamp the hoses to a clamping assembly, and further securely couple the clamping assembly with the frame of the machine.

WIPO publication number WO2006128526, hereinafter referred to as ‘the '526 publication’ discloses a holder for hoses. The holder includes a bottom part and a top part placed thereon. Both the bottom part and the top part each have a groove in the form of a circle arc to form an accommodating opening for accommodating a hose or a pipe. A set of bores are formed in order for the bottom part to be mounted at a mounting location. At least one protrusion and at least one depression are formed in the region of the connecting surface between the top part and bottom part and form the inter-engaging elements. The protrusion or the depression on one side in relation to a vertical centre plane corresponds to a corresponding depression or a corresponding protrusion on the other side of the centre plane. However, the '526 publication fails to disclose a coupling arrangement which securely holds the hoses, which carries high pressure fluid, to the mounting portion.

### SUMMARY OF THE DISCLOSURE

In one aspect of the present disclosure, a clamping member is provided. The clamping member includes a first receptacle and a second receptacle. The clamping member further includes a mounting portion defined between the first receptacle and the second receptacle. The mounting portion has a first end and a second end distal to the first end. The mounting portion is configured to couple to a frame of a machine using fastening members. The clamping member further includes a locating member disposed on the mounting portion at a first distance from the first end of the mounting portion. The clamping member further includes a holding portion defined in the mounting portion at a second distance from the second end of the mounting portion. The first distance and the second distance are equal. The clamping member further includes a plurality of engaging members defined at the first end of the mounting portion. The clamping member further includes a leg member having a tab disposed at the second end of the mounting portion. The tab conforms with the plurality of engaging members.

In another aspect of the present disclosure, a clamping assembly for attaching a hose with a frame of a machine is provided. The clamping assembly includes a pair of identical clamping members. The pair of identical clamping members includes a first clamping member and a second clamping member. Each of the first clamping member and the second clamping member includes a first receptacle, a second receptacle, and a mounting portion defined between the first receptacle and the second receptacle. The mounting portion has a pair of receiving portions. At least one of the first receptacle and the second receptacle of each of the first clamping member and the second clamping member is configured to receive the hose. Each of the first clamping member and the second clamping member further includes a locating member disposed on the mounting portion and a holding portion defined in the mounting portion. The locating member of one of the first clamping member and the second clamping member is received within the holding portion of one of the first clamping member and the second clamping member. Each of the first clamping member and the second clamping member further includes a plurality of engaging members defined at a first end of the mounting portion and a leg member having a tab disposed at a second end of the mounting portion. The tab of the leg member of one of the first clamping member and the second clamping member is configured to engage with one of the plurality of engaging members of one of the first clamping member and the second clamping member. The clamping assembly further includes a fastening member received through each of the pair of receiving portions of each of the first clamping member and the second clamping member to couple the first clamping member and the second clamping member to the frame of the machine.

In yet another aspect of the present disclosure, a machine is provided. The machine includes a frame and a pair of identical clamping members configured to clamp at least one hose with the frame. The pair of identical clamping members includes a first clamping member and a second clamping member. Each of the first clamping member and the second clamping member includes a first receptacle, a second receptacle, and a mounting portion defined between the first receptacle and the second receptacle. The mounting portion has a pair of receiving portions for receiving fastening members therethrough. At least one of the first receptacle and the second receptacle of each of the first clamping member and the second clamping member is configured to receive the at least one hose. The fastening members are configured to couple the first clamping member and the second clamping member to the frame. Each of the first clamping member and the second clamping member includes a locating member disposed on the mounting portion and a holding portion defined in the mounting portion. The locating member of one of the first clamping member and the second clamping member is received within the holding portion of one of the first clamping member and the second clamping member. Further, each of the first clamping member and the second clamping member includes a plurality of engaging members defined at a first end of the mounting portion and a leg member having a tab disposed at a second end of the mounting portion. The tab of the leg member of one of the first clamping member and the second clamping member is engaged with one of the plurality of engaging members of one of the first clamping member and the second clamping member.

Other features and aspects of this disclosure will be apparent from the following description and the accompanying drawings.

### BRIEF DESCRIPTION OF THE DRAWINGS

FIG. 1 is a perspective view of a machine having a clamping assembly for attaching hoses with a frame of the machine, according to an embodiment of the present disclosure;

FIG. 2 is a perspective view of the clamping assembly showing a pair of identical clamping members, according to an embodiment of the present disclosure;

FIG. 3 is a perspective view of one clamping member of the pair of identical clamping members of FIG. 2, according to an embodiment of the present disclosure; and

FIG. 4 is a sectional view of the one clamping member taken along a line A-A′ of FIG. 3, according to an embodiment of the present disclosure.

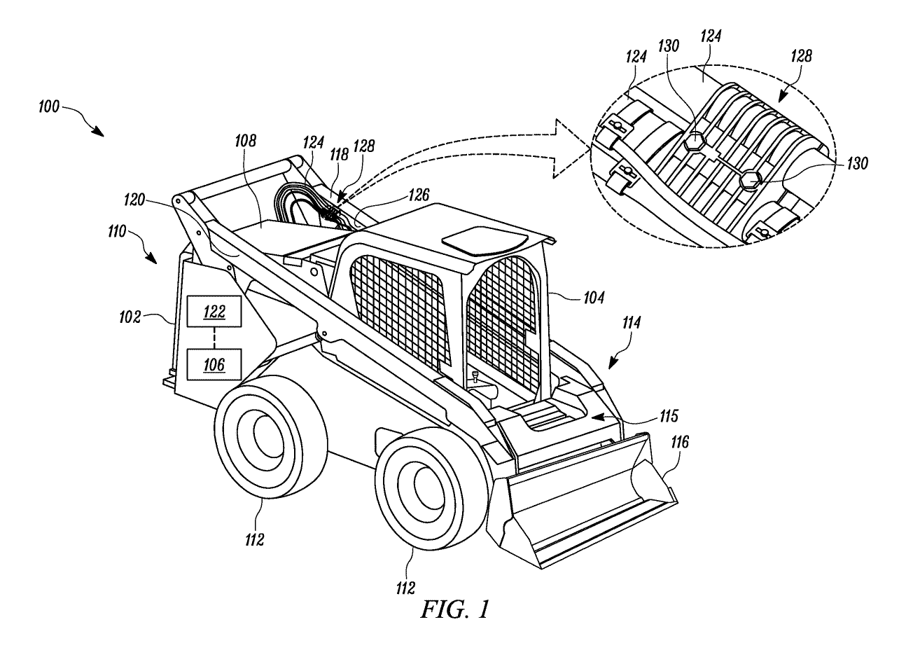

### DETAILED DESCRIPTION

Wherever possible, the same reference numbers will be used throughout the drawings to refer to the same or the like parts. FIG. 1 illustrates a perspective view of a machine 100. The machine 100, according to an embodiment of the present disclosure, is a skid steer loader. Although, embodiments of the present disclosure are disclosed in conjunction with the skid steer loader, it will be appreciated that the embodiments of the present disclosure disclosed herein can be similarly applied to other types of machines such as a track type loader, a multi-terrain loader, a compact track loader, a mining shovel, a wheel loader, a backhoe loader, a motor grader, a track type tractor, a wheeled tractor, a paver, an excavator, a material handler, and a forestry machine. Further, the machine 100 may be associated with various industries such as mining, forestry, construction and quarry, transportation, logistics, and agriculture.

The machine 100 includes a frame 102 and an operator cabin 104 mounted on the frame 102. The operator cabin 104 may include control elements, such as a joystick for controlling operations of the machine 100. A powertrain including a power source 106 is disposed in the machine 100 to supply power for performing various operations of the machine 100. An enclosure 108 is provided at a rear end 110 of the machine 100 to house the power source 106. The power source 106 may be, but not limited to, an internal combustion engine, a hybrid engine, and non-conventional power sources such as batteries and fuel cells. The powertrain may further include a transmission unit (not shown) for transmission of the power from the power source 106 to a set of ground engaging members 112. In the illustrated embodiment, the set of ground engaging members 112 is wheels. In an alternative embodiment, the set of ground engaging members 112 may be tracks.

The machine 100 further includes an implement system 114 coupled to the frame 102. The implement system 114 includes a set of lift arms, and a work implement 116 pivotally coupled to the set of lift arms and disposed at a front end 115 of the machine 100. The set of lift arms includes a first lift arm 118 and a second lift arm 120. Each of the first lift arm 118 and the second lift arm 120 is pivotally coupled to the frame 102 at the rear end 110 of the machine 100.

The machine 100 further includes a hydraulic system 122 coupled to the power source 106. In the illustrated embodiment, the hydraulic system 122 is disposed within the enclosure 108 at the rear end 110 of the machine 100. The hydraulic system 122 may include various components, such as a reservoir, one or more hydraulic pumps, one or more direction control valves, and other control valves, for supplying hydraulic fluid at a desired pressure to various operating systems, such as the implement system 114, of the machine 100. The one or more hydraulic pumps of the hydraulic system 122 may be operatively coupled with the power source 106 to receive the power therefrom. Upon receiving the power from the power source 106, the one or more hydraulic pumps may supply the hydraulic fluid to the various operating systems of the machine 100 via hoses 124.

As mentioned earlier, the hydraulic system 122 is disposed at the rear end 110 of the machine 100 and each of the work implement 116, the first lift arm 118, the second lift arm 120 and the various operating systems of the machine 100 is located at different locations in the machine 100. Hence, the hoses 124 may be routed from the one or more hydraulic pumps to a hydraulic actuator (not shown) associated with each of the work implement 116, the first lift arm 118, and the second lift arm 120 in such a way to avoid entangling with other moving parts of the machine 100. A clamping assembly 128, according to an embodiment of the present disclosure, is used for attaching the hoses 124 with a surface 126 of the frame 102. The clamping assembly 128 is further coupled to the surface 126 of the frame 102 using fastening members 130, such as bolts and studs.

In an example, referring to FIG. 1, a hydraulic pump is fluidly coupled to the hydraulic actuator of the work implement 116 via the hoses 124. The hoses 124 are routed from the hydraulic pump to the work implement 116 by attaching the hoses 124 on to the surface 126 of the first lift arm 118 using the clamping assembly 128. Further, the clamping assembly 128 may couple the hoses 124 to any component of the machine 100, such as the operator cabin 104, to secure the hoses 124 with the frame 102 of the machine 100 along a length thereof. Number of clamping assemblies 128 may vary based on number of the hoses 124, and size and shape of the hoses 124. Accordingly, a plurality of the hoses 124 coupled to the surface 126 of the first lift arm 118 is explained in detail for illustration purpose of the present disclosure.

Although the embodiments of the present disclosure are described in conjunction with the clamping assembly 128 for attaching the hoses 124 that supply hydraulic fluid to the hydraulic actuator associated with the work implement 116, it will be appreciated that the clamping assembly 128 may be employed to attach the hoses 124 used for supplying hydraulic fluid to the various operating systems of the machine 100.

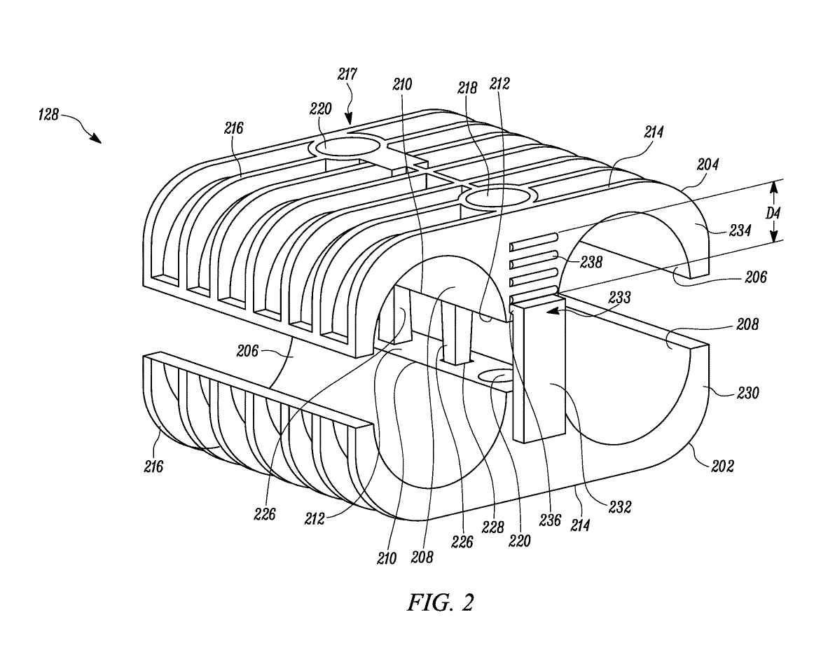

FIG. 2 illustrates a perspective view of the clamping assembly 128, according to an embodiment of the present disclosure. The clamping assembly 128 is configured to attach the hoses 124 with the frame 102 of the machine 100. In the illustrated example, the clamping assembly 128 is configured to attach the hoses 124 with the first lift arm 118 of the machine 100. The clamping assembly 128 may be made from a variety of materials including, but not limited to, carbon steel, stainless steel, aluminum and plastic.

The clamping assembly 128 includes a pair of identical clamping members, which includes a first clamping member 202 and a second clamping member 204. Each of the first clamping member 202 and the second clamping member 204 includes a first receptacle 206 and a second receptacle 208. In the illustrated embodiment, each of the first receptacle 206 and the second receptacle 208 includes an arcuate portion that is configured to receive the hoses 124. More specifically, the arcuate portion of each of the first receptacle 206 and the second receptacle 208 has a semi-circular cross-sectional shape. In other embodiments, the arcuate portion of each of the first receptacle 206 and the second receptacle 208 may include a semi-elliptical cross-sectional shape to receive the hoses 124. In the illustrated embodiment, each of the first receptacle 206 and the second receptacle 208 has an identical cross-sectional shape and dimension. In another embodiment, each of the first receptacle 206 and the second receptacle 208 may have different cross-sectional shape and dimension. For example, the first receptacle 206 may have a semi-circular cross-sectional shape and the second receptacle 208 may have a square cross-sectional shape.

Each of the first clamping member 202 and the second clamping member 204 further includes a mounting portion 210. The mounting portion 210 is defined between the first receptacle 206 and the second receptacle 208. The mounting portion 210 is configured to couple to the frame 102 of the machine 100 using fastening members 130. The mounting portion 210 includes a first planar surface 212 and a second planar surface 214 parallel to the first planar surface 212. The first planar surface 212 of each of the first clamping member 202 and the second clamping member 204 is configured to abut each other. Further, the second planar surface 214 of one of the first clamping member 202 and the second clamping member 204 is configured to abut the frame 102 of the machine 100. In the illustrated example, the second planar surface 214 of one of the first clamping member 202 and the second clamping member 204 is configured to abut the surface 126 of the first lift arm 118 of the machine 100.

In the illustrated embodiment, multiple ribs 216 are defined on the second planar surface 214 of each of the first clamping member 202 and the second clamping member 204. The multiple ribs 216 may aid in increasing structural rigidity of the first and second clamping members 202, 204. In addition, the multiple ribs 216 may provide an improved grip to the clamping assembly 128 when one of the first clamping member 202 and the second clamping member 204 is attached to the frame 102 of the machine 100.

A pair of receiving portions 217 is defined in the mounting portion 210 of each of the first clamping member 202 and the second clamping member 204. The pair of receiving portions 217 includes a first receiving portion 218 and a second receiving portion 220. Each of the first receiving portion 218 and the second receiving portion 220 is defined in the mounting portion 210 and extends from the first planar surface 212 to the second planar surface 214 of the mounting portion 210. Each of the first receiving portion 218 and the second receiving portion 220 of the first clamping member 202 and the second clamping member 204 is configured to receive the fastening members 130 therethrough. As such, the clamping assembly 128 having the pair of identical clamping members is attached to the frame 102 of the machine 100 for securing the hoses 124 therewith.

Each of the first clamping member 202 and the second clamping member 204 further includes a locating member 226 and a holding portion 228. The locating member 226 is disposed on the first planar surface 212 of the mounting portion 210 of each of the first clamping member 202 and the second clamping member 204. In the illustrated embodiment, the locating member 226 has a square cross-sectional shape. In other embodiments, the locating member 226 may have one of various cross-sectional shapes such as circle, elliptical, and polygon. The holding portion 228 extends from the first planar surface 212 of the mounting portion 210 of each of the first clamping member 202 and the second clamping member 204. In an example, the locating member 226 of the second clamping member 204 is configured to be received within the holding portion 228 defined in the mounting portion 210 of the first clamping member 202, a shown in FIG. 2. Similarly, the locating member 226 of the first clamping member 202 is received within the holding portion 228 defined in the mounting portion 210 of the second clamping member 204. In some embodiments, the locating member 226 and the holding portion 228 may have different cross-sectional shapes.

A leg member 232 is disposed on a side surface 230, hereinafter referred to as ‘the first side surface 230’, of each of the first clamping member 202 and the second clamping member 204. The leg member 232 extends vertically upward from the first planar surface 212 of the mounting portion 210 of each of the first clamping member 202 and the second clamping member 204. The leg member 232 includes a tab 236 attached to a top end 233 of the leg member 232. The tab 236 extends radially away from the leg member 232. A chamfering portion (not shown) is provided along a top side edge and a bottom side edge of the tab 236. A plurality of engaging members 238 is defined on a side surface 234, hereinafter referred to as ‘the second side surface 234’, of each of the first clamping member 202 and the second clamping member 204. In one embodiment, each of the plurality of engaging members 238 has a curvilinear surface. Due to the chamfering portions of the tab 236 and the curvilinear surface of the plurality of engaging members 238, the tab 236 of the leg member 232 of the first clamping member 202 is configured to slidably engage with the plurality of engaging members 238 of the second clamping member 204. Similarly, the tab 236 of the leg member 232 of the second clamping member 204 is configured to slidably engage with the plurality of engaging members 238 of the first clamping member 202. Thus, the tab 236 is designed in such a way that the tab 236 conforms with a design of the plurality of engaging members 238. As such, the hoses 124 are clamped between the first receptacle 206 and the second receptacle 208 of each of the first clamping member 202 and the second clamping member 204.

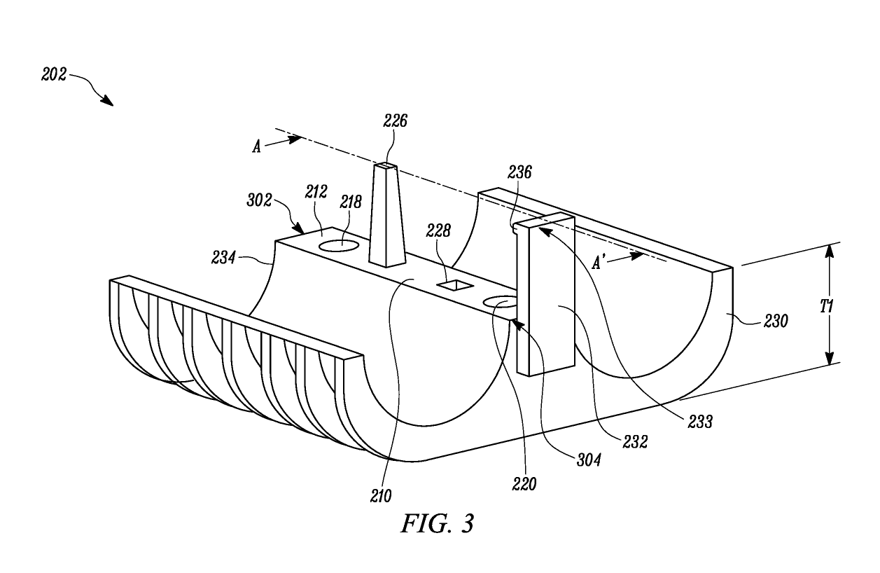

FIG. 3 illustrates a perspective view of the first clamping member 202 of the clamping assembly 128. As the first clamping member 202 is identical to the second clamping member 204, the first clamping member 202 is explained in detail for illustration purpose of the present disclosure. The first receiving portion 218 is defined proximal to a first end 302 of the mounting portion 210 and the second receiving portion 220 is defined proximal to a second end 304 of the mounting portion 210. Each of the first receiving portion 218 and the second receiving portion 220 extends between the first planar surface 212 and the second planar surface 214 of the mounting portion 210 to receive the fastening members 130 therethrough.

The locating member 226 of the first clamping member 202 is disposed on the first planar surface 212 of the mounting portion 210. The locating member 226 further extends vertically up to a predefined height. The predefined height of the locating member 226 may vary based on various factors including, but not limited to, a thickness ‘Ti’ of the first clamping member 202 defined between the first planar surface 212 and the second planar surface 214, a size and a shape of the hoses 124. In one embodiment, a cross-sectional area of the locating member 226 linearly decreases from an end defined adjacent to the first planar surface 212 to a free end, as shown in the FIG. 3. In another embodiment, a cross-sectional area remains constant throughout the predefined height of the locating member 226. In the illustrated embodiment, the locating member 226 is an integral part of the first clamping member 202. Alternatively, the locating member 226 may be an individual component coupled to the first planar surface 212.

The holding portion 228 of the first clamping member 202 is defined in the mounting portion 210. The holding portion 228 extends vertically downward towards the second planar surface 214 of the mounting portion 210 up to a predefined depth. In one embodiment, the predefined height of the locating member 226 is equal to the predefined depth of the holding portion 228. In another embodiment, the predefined height of the locating member 226 may be less than the predefined depth of the holding portion 228.

The leg member 232 is disposed on the first side surface 230 at the second end 304 of the mounting portion 210 of the first clamping member 202. The leg member 232 extends vertically upward from the first planar surface 212 of the mounting portion 210. In the illustrated embodiment, a cross-sectional area of the leg member 232 is constant throughout a length of the leg member 232. Alternatively, the cross-sectional area of the leg member 232 may linearly decrease towards the top end 233 of the leg member 232. In the illustrated embodiment, the tab 236 is formed as an integral part of the leg member 232 at the top end 233 thereof. Due to the chamfering portion provided along the top side edge and the bottom side edge of the tab 236, the tab 236 slidably engages with the plurality of engaging members 238 (shown in FIG. 2), disposed on the second side surface 234 of the mounting portion 210 of the second clamping member 204. In the illustrated embodiment, a thickness of the tab 236 is equal to a distance defined between two adjacent engaging members among the plurality of engaging members 238. The plurality of engaging members 238 is defined on the second side surface 234 of the mounting portion 210 of the first clamping member 202. In another embodiment, multiple recesses may be defined on the second side surface 234 of the mounting portion 210 of the first clamping member 202 to form the plurality of engaging members 238. In the illustrated embodiment, the leg member 232 and the plurality of engaging members 238 are an integral part of the first clamping member 202. Alternatively, the leg member 232 and the plurality of engaging members 238 may be separately coupled to the first clamping member 202.

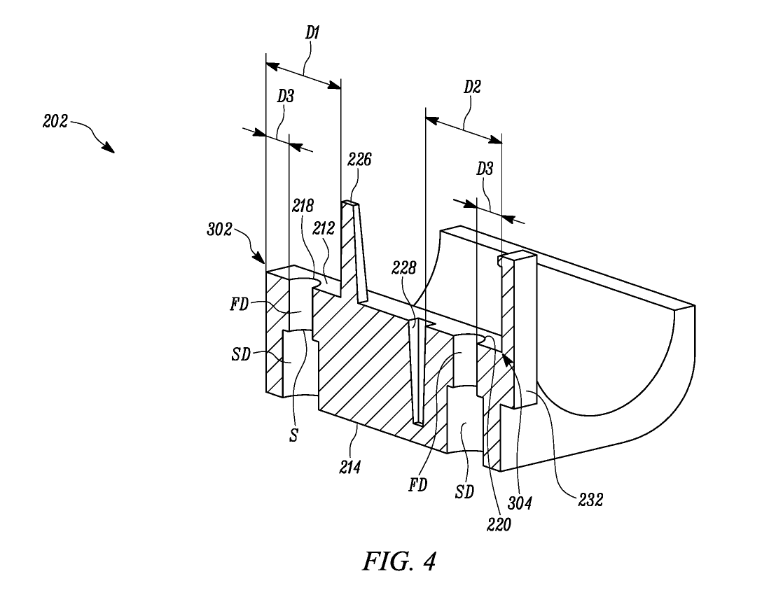

FIG. 4 illustrates a sectional view of the first clamping member 202 taken along a line A-A′ of FIG. 3. The locating member 226 is disposed at a first distance ‘D1’ from the first end 302 of the mounting portion 210. Further, the holding portion 228 is defined at a second distance ‘D2’ from the second end 304 of the mounting portion 210. The first distance ‘D1’ and the second distance ‘D2’ are equal. As such, the holding portion 228 of the second clamping member 204 is aligned with the locating member 226 of the first clamping member 202. Further, the holding portion 228 of the first clamping member 202 is aligned with the locating member 226 of the second clamping member 204. The first receiving portion 218 is defined proximal to the first end 302 of the mounting portion 210 at a third distance ‘D3’. Similarly, the second receiving portion 220 is defined proximal to the second end 304 of the mounting portion 210 at the third distance ‘D3’. Thus, each of the pair of receiving portions 217 is defined proximal to each of the first end 302 and the second end 304 of the mounting portion 210 at an equal distance. The leg member 232 extends vertically upward from the first planar surface 212 of the mounting portion 210 to a length. Correspondingly, the plurality of engaging members 238 is disposed on the second side surface 234 of the mounting portion 210 at a predefined distance ‘D4’ (shown in FIG. 2) from the first planar surface 212. The length of the leg member 232 is equal to or greater than the predefined distance ‘D4’, which is also referred to as the fourth distance ‘D4’.

Further, each of the first receiving portion 218 and the second receiving portion 220 includes a first diametric portion ‘FD’ and a second diametric portion ‘SD’. In the illustrated embodiment, the first diametric portion ‘FD’ is defined proximal to the first planar surface 212 and the second diametric portion ‘SD’ is defined proximal to the second planar surface 214. Further, the second diametric portion ‘SD’ is greater than the first diametric portion ‘FD’. Owing to such difference in the first and second diametric portions ‘FD’, ‘SD’, a step portion ‘S’ is formed at a junction where the first diametric portion ‘FD’ connects the second diametric portion ‘SD’. As such, in an embodiment, the step portion ‘S’ may function as a seat such that a head portion of the fastening member 130 may rest thereon. More specifically, the first diametric portion ‘FD’ may receive a shank portion of the fastening member 130 and the second diametric portion ‘SD’ may receive the head portion of the fastening member 130. Thus, the head portion of the fastening members 130 may be disposed below the second planar surface 214.

For mounting of the clamping assembly 128 onto the surface 126 of the frame, in one example, a nut may be welded to the surface 126 of the frame 102 of the machine 100 to threadably engage with the fastening member 130. In such a case, the second diametric portion ‘SD’ may also be configured to receive the nut therein so that the second planar surface 214 may abut the surface 126 of the frame 102 of the machine 100.

### INDUSTRIAL APPLICABILITY

The present disclosure relates to the clamping assembly 128 for attaching the hoses 124 with the frame 102 of the machine 100. The clamping assembly 128 includes the pair of identical clamping members, such as the first clamping member 202 and the second clamping member 204. Each of the pair of identical clamping members includes the first receptacle 206, the second receptacle 208, and the mounting portion 210 defined between the first receptacle 206 and the second receptacle 208. As such, the pair of identical clamping members together enables coupling of a pair of the hoses 124 or multiple hoses 124 with the frame 102 of the machine 100. Similarly, multiples of such clamping assemblies 128 are used for coupling the hoses 124 with the frame 102 of the machine 100. Accordingly, a plurality of such clamping members can be developed and a pair of the clamping members can be used for coupling the hoses 124 with the frame 102 of the machine 100.

The locating member 226 of one clamping member of the pair of identical clamping members is received within the holding portion 228 of another clamping member of the pair of identical clamping members. Thus, the locating member 226 and the holding portion 228 enable alignment of the pair of identical clamping members during assembly thereof. The locating member 226 may further provide torsional strength to the clamping assembly 128, as the locating member 226 may prevent angular movement of the pair of identical clamping members with respect to each other during assembly thereof. During the alignment of the pair of identical clamping members, the leg member 232 of one clamping member of the pair of identical clamping members is aligned with the plurality of engaging members 238 of another clamping member of the pair of identical clamping members.

The tab 236 of the leg member 232 slidably engages with the plurality of engaging members 238 during assembly of the pair of identical clamping members. In an example, the hoses 124 are placed within each of the first receptacle 206 and the second receptacle 208 of the first clamping member 202. Subsequently, the second clamping member 204 of the clamping assembly 128 is placed on the hoses 124. As such, the locating member 226 of each of the first clamping member 202 and the second clamping member 204 is received within the holding portion 228 of each of the first clamping member 202 and the second clamping member 204. Further, the tab 236 of the leg member 232 of the first clamping member 202 slidably engages with the plurality of engaging members 238 of the second clamping member 204. Similarly, the tab 236 of the leg member 232 of the second clamping member 204 slidably engages with the plurality of engaging members 238 of the first clamping member 202. The tab 236 of the leg member 232 slidably engages with respective engaging members among the plurality of engaging members 238 based on the size of the hoses 124. As such, the hoses 124 are securely clamped between the first clamping member 202 and the second clamping member 204. Further, the fastening members 130 are received through the first receiving portion 218 and the second receiving portion 220 to hold each of the first clamping member 202 and the second clamping member 204 together. The fastening members 130 further enables coupling of the clamping assembly 128 to the frame 102 of the machine 100. As such, the hoses 124, irrespective of the size and the shape, are securely held between the first clamping member 202 and the second clamping member 204 and are further securely attached to the frame 102 of the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A clamping member, comprising:
a first receptacle;
a second receptacle;
a mounting portion defined between the first receptacle and the second receptacle, and having a first end and a second end distal to the first end, the mounting portion configured to couple to a frame of a machine using fastening members;
a locating member disposed on the mounting portion at a first distance from the first end;
a holding portion defined in the mounting portion at a second distance from the second end, wherein the first distance and the second distance are equal;
a plurality of engaging members defined at the first end of the mounting portion; and
a leg member having a tab disposed at the second end of the mounting portion, wherein the tab conforms with the plurality of engaging members.

2. The clamping member of claim 1, wherein each of the first receptacle and the second receptacle comprises an arcuate portion configured to receive a hose.

3. The clamping member of claim 1, wherein the mounting portion comprises a first planar surface, and a second planar surface parallel to the first planar surface, and wherein the second planar surface is configured to abut the frame of the machine.

4. The clamping member of claim 3, wherein the mounting portion comprises a pair of receiving portions configured to receive the fastening members, and wherein each of the pair of receiving portions comprises a first diametric portion defined proximal to the first planar surface and a second diametric portion defined proximal to the second planar surface.

5. The clamping member of claim 4, wherein each of the pair of receiving portions is defined proximal to each of the first end and the second end of the mounting portion at a third distance.

6. The clamping member of claim 1, wherein the plurality of engaging members is disposed on a side surface defined at the first end of the mounting portion.

7. The clamping member of claim 1, wherein the leg member extends vertically from a side surface defined at the second end of the mounting portion.

8. The clamping member of claim 1, wherein the locating member and the holding portion have an identical cross-sectional shape.

9. A clamping assembly for attaching a hose with a frame of a machine, the clamping assembly comprising:
a pair of identical clamping members comprising a first clamping member and a second clamping member, each of the first clamping member and the second clamping member comprising:
a first receptacle;
a second receptacle;
a mounting portion defined between the first receptacle and the second receptacle, and having a pair of receiving portions, wherein at least one of the first receptacle and the second receptacle of each of the first clamping member and the second clamping member is configured to receive the hose;
a locating member disposed on the mounting portion;
a holding portion defined in the mounting portion, wherein the locating member of one of the first clamping member and the second clamping member is received within the holding portion of one of the first clamping member and the second clamping member;
a plurality of engaging members defined at a first end of the mounting portion; and
a leg member having a tab disposed at a second end of the mounting portion, wherein the tab of the leg member of one of the first clamping member and the second clamping member is configured to engage with one of the plurality of engaging members of one of the first clamping member and the second clamping member; and
a fastening member received through each of the pair of receiving portions of each of the first clamping member and the second clamping member to couple the first clamping member and the second clamping member to the frame of the machine.

10. The clamping assembly of claim 9, wherein each of the first receptacle and the second receptacle comprises an arcuate portion configured to receive the hose.

11. The clamping assembly of claim 9, wherein the mounting portion comprises a first planar surface, and a second planar surface parallel to the first planar surface, and wherein the first planar surface of each of the first clamping member and the second clamping member is configured to abut each other and the second planar surface of one of the first clamping member and the second clamping member is configured to abut the frame of the machine.

12. The clamping assembly of claim 11, wherein each of the pair of receiving portions comprises a first diametric portion defined proximal to the first planar surface and a second diametric portion defined proximal to the second planar surface.

13. The clamping assembly of claim 9, wherein each of the plurality of engaging members is disposed on a side surface defined at the first end of the mounting portion.

14. The clamping assembly of claim 9, wherein the leg member extends vertically from a side surface defined at the second end of the mounting portion, and wherein the tab of the leg member is configured to slidably engage with one of the plurality of engaging members.

15. The clamping assembly of claim 9, wherein each of the pair of receiving portions is defined proximal to each of the first end and the second end of the mounting portion at an equal distance.

16. The clamping assembly of claim 9, wherein the locating member and the holding portion have an identical cross-sectional shape.

17. A machine comprising:
a frame; and
a pair of identical clamping members configured to clamp at least one hose with the frame, the pair of identical clamping members comprising a first clamping member and a second clamping member, each of the first clamping member and the second clamping member comprising:
a first receptacle;
a second receptacle;
a mounting portion defined between the first receptacle and the second receptacle, and having a pair of receiving portions for receiving fastening members therethrough, wherein at least one of the first receptacle and the second receptacle of each of the first clamping member and the second clamping member is configured to receive the at least one hose, and wherein the fastening members are configured to couple the first clamping member and the second clamping member to the frame;
a locating member disposed on the mounting portion;
a holding portion defined in the mounting portion, wherein the locating member of one of the first clamping member and the second clamping member is received within the holding portion of one of the first clamping member and the second clamping member;
a plurality of engaging members defined at a first end of the mounting portion; and
a leg member having a tab disposed at a second end of the mounting portion, wherein the tab of the leg member of one of the first clamping member and the second clamping member is engaged with one of the plurality of engaging members of one of the first clamping member and the second clamping member.

18. The machine of claim 17, wherein the mounting portion comprises a first planar surface and a second planar surface parallel to the first planar surface, and wherein the first planar surface of each of the first clamping member and the second clamping member is configured to abut each other and the second planar surface of one of the first clamping member and the second clamping member is configured to abut the frame of the machine.
